(19) United States
(12) Patent Application Publication
(10) Pub. No.: US 2022/0108237 A1
(43) Pub. Date: Apr. 7, 2022

(54) SYSTEM AND METHOD FOR PREDICTIVE CORRUPTION RISK ASSESSMENT

(71) Applicant: Ethimetrix LLC, Oak Park, IL (US)

(72) Inventors: Adriaan Denkers, Oak Park, IL (US); Robert Kent, Oak Park, IL (US)

(21) Appl. No.: 17/479,841

(22) Filed: Sep. 20, 2021

Related U.S. Application Data
(60) Provisional application No. 63/080,545, filed on Sep. 18, 2020.

(51) Int. Cl. G06Q 10/06

(52) U.S. Cl. CPC G06Q 10/0635

(57) ABSTRACT

The method for predictive corruption risk assessment includes identifying a target for assessing corruption risk. A set of misconduct data requests are provided. Misconduct input associated with each misconduct data request in the set of misconduct data requests is received. A set of predictive factors data requests are provided. Predictive factors input associated with each predictive factors data request in the set of predictive factors data requests is received. The misconduct input and the predictive factors input are aggregated. The set of predictive factors data requests statistically correlate with the set of misconduct data requests. Each predictive factors data request of the set of predictive factors data requests is from at least one or more categories. The aggregated misconduct and predictive factors inputs are analyzed. A report based on the analysis is generated and the report reflects the aggregated misconduct and predictive factors inputs.

### CROSS-REFERENCE TO RELATED APPLICATION(S)

This application claims the benefit of and priority to U.S. Provisional Application No. 63/080,545, filed on Sep. 18, 2020, entitled “SYSTEM AND METHOD FOR PREDICTIVE CORRUPTION RISK ASSESSMENT,” which is hereby incorporated by reference in its entirety.

### TECHNICAL FIELD

The present systems and methods are directed to providing a psychometric test and associated processes that can assist with the measurement, prediction, and reduction of corruption risk.

### BACKGROUND

In the United States, and in many countries, using bribes or rewards, monetary or otherwise, to influence others (e.g., government officials) to take or not take certain actions and for the purpose of obtaining or retaining business is illegal. In the United States, the Foreign Corrupt Practices Act (“FCPA”), the controlling federal statute, also prohibits other activities such as false entries in a company's records.

The FCPA enforcement surge began in 2004 and is ongoing. From 2016 through 2020, United States enforcement authorities averaged 43 FCPA enforcement actions per year. In both 2018 and 2019, total FCPA enforcement penalties exceeded $2.9 billion, and in 2020 the total was $6.4 billion. When violations occur, in addition to enforcement penalties, companies incur substantial investigation costs and reputational damage. The anti-corruption enforcement authorities of countries other than the United States have also become more active and aggressive in pursuing violations.

To prevent corruption and related corruption enforcement, companies spend millions of dollars annually on compliance programs. Many consulting firms and company compliance departments work to identify, predict and mitigate bribery and false records risk, but their tools and impact are limited, and corruption and related enforcement continues onward, seemingly unabated. In this context, it would be advantageous to have a system and method for measuring, predicting and managing corruption risks prior to the occurrence of illegal activity.

There have been some attempts to provide predictive analytics for certain illegal activity such as insider fraud as shown in U.S. Pat. No. 8,868,728. This patent discloses a method for identifying one or more insider threat detection rules for an enterprise and obtaining behavioral data for an enterprise insider from multiple behavioral data sources. However, this system is limited to the detecting and investigating fraud and, more particularly, to methods and apparatuses for detecting and investigating insider fraud. United States Patent Publication 2017/0330117 is directed generally to a system for predicting whether individuals are likely to participate in a specific activity which may represent a threat to an organization. This publication is limited to harvesting data indicative of psychological precursors of a class of insider threats from one or more data sources. These data sources are closed circuit television (CCTV), video and sound recording, location and acceleration recording, monitoring of electronic communications and computer systems usage, environmental monitoring. Therefore, the data collected is limited to pre-existing data, which is not targeted to detect corruption as in the present system and is limited to enterprise insiders whereas the present system applies to both insiders and outsiders. Currently the prior art does not include a psychometric test that is used to measure or predict corruption proneness, as is accomplished through the present system.

The current measures of corruption in a particular country or group available in the market rely on indirect measures such as certain people's opinions or data about the country's enforcement regime, or demographic data about the group. These approaches have disadvantages not present in the current system because they do not access direct information about the extent to which corruption exists in the identified country or group. The current available tools used to conduct anti-corruption due diligence and risk assessments, such as public record checks, company questionnaires and interviews, do not collect information about and analyze what the relevant people have done in secret and their actual attitudes and beliefs. As a result, the tools are sub-optimal because their approach is necessarily superficial.

### SUMMARY

In one aspect, the subject matter of this disclosure relates to a method for predictive corruption risk assessment. According to one embodiment, the method includes identifying a target for assessing corruption risk. A set of misconduct data requests are provided. Misconduct input associated with each misconduct data request in the set of misconduct data requests is received. A set of predictive factors data requests are provided. Predictive factors input associated with each predictive factors data request in the set of predictive factors data requests is received. The misconduct input and the predictive factors input are aggregated. The set of predictive factors data requests statistically correlate with the set of misconduct data requests. Each predictive factors data request of the set of predictive factors data requests is from at least one or more categories. The aggregated misconduct and predictive factors inputs are analyzed. A report based on the analysis is generated and the report reflects the aggregated misconduct and predictive factors inputs.

These and other objects, along with advantages and features of embodiments of the present invention herein disclosed, will become more apparent through reference to the following description, the figures, and the claims. Furthermore, it is to be understood that the features of the various embodiments described herein are not mutually exclusive and can exist in various combinations and permutations.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 is a flowchart of a process for predictive corruption risk assessment, according to an embodiment of the present disclosure.

FIG. 2 is a schematic diagram of a system for predictive corruption risk assessment, according to an embodiment of the present disclosure;

FIG. 3 is a flowchart of a process for a prediction of corruption, according to an embodiment of the present disclosure;

FIG. 4 is a schematic of a user device for performing a method, according to an embodiment of the present disclosure;

FIG. 5 is a schematic of a hardware system for performing a method, according to an embodiment of the present disclosure; and

FIG. 6 is a schematic of a hardware configuration of a device for performing a method, according to an embodiment of the present disclosure.

### DETAILED DESCRIPTION

It is contemplated that apparatus, systems, methods, and processes of the claimed invention encompass variations and adaptations developed using information from the embodiments described herein. Adaptation and/or modification of the apparatus, systems, methods, and processes described herein may be performed by those of ordinary skill in the relevant art.

It should be understood that the order of steps or order for performing certain actions is immaterial so long as the invention remains operable. Moreover, two or more steps or actions may be conducted simultaneously.

With reference to the drawings, the invention will now be described in more detail. The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). Reference throughout this document to “one embodiment”, “certain embodiments”, “an embodiment”, “an implementation”, “an example” or similar terms means that a particular feature, structure, or characteristic described in connection with the embodiment is included in at least one embodiment of the present disclosure. Thus, the appearances of such phrases or in various places throughout this specification are not necessarily all referring to the same embodiment. Furthermore, the particular features, structures, or characteristics may be combined in any suitable manner in one or more embodiments without limitation.

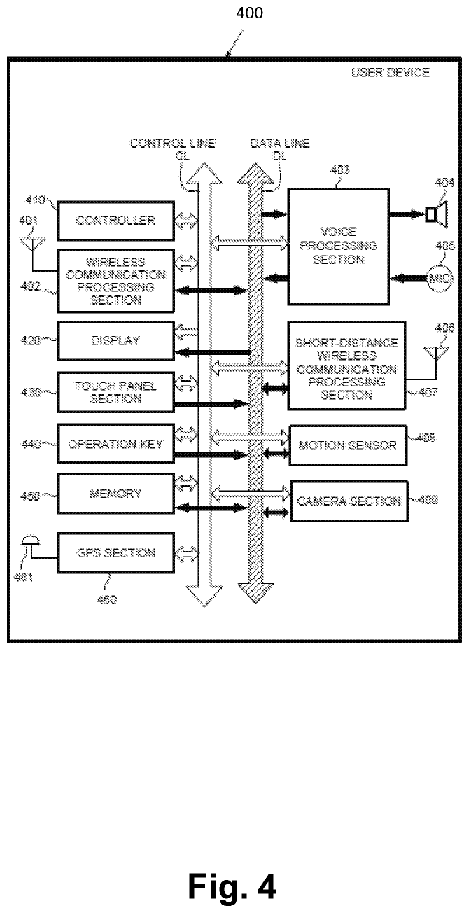

The present disclosure describes a system, which is a flexible tool that can be used in several different ways, depending on the user's desired objective. If the user's objective is to measure corruption in a particular country or group, the system can ask the identified respondent(s) the misconduct questions and the social desirability questions and analyze and measure the admitted misconduct on a respondent's or a user device (discussed in detail later in FIG. 4 herein), for example, by contrasting misconduct scores against pre-calculated gender, age and/or social desirability specific t-scores.

In one embodiment, if the objective of the user of the system is to measure and predict the likelihood that the respondent(s) have engaged in misconduct, the system can ask the identified respondent(s) the predictive factors questions and the social desirability questions, and calculate the likelihood of misconduct, for example, by utilizing the formula, derived from a regression analysis predicting misconduct in the reference norm population, on the identified respondent(s) scores on the predictive factors and the social desirability items.

In one embodiment, if the user's objective includes the goal of further studying the relationship between the predictive factors and the misconduct, the system can ask the identified respondent(s) the misconduct questions, the predictive factors questions, and the social desirability questions, and calculate the relationship between the predictive factors and the misconduct. For example, by calculating gender, age, function and/or social desirability specific t-scores, or by constructing formulas that predict misconduct with a mix of the predictive factors and the social desirability questions.

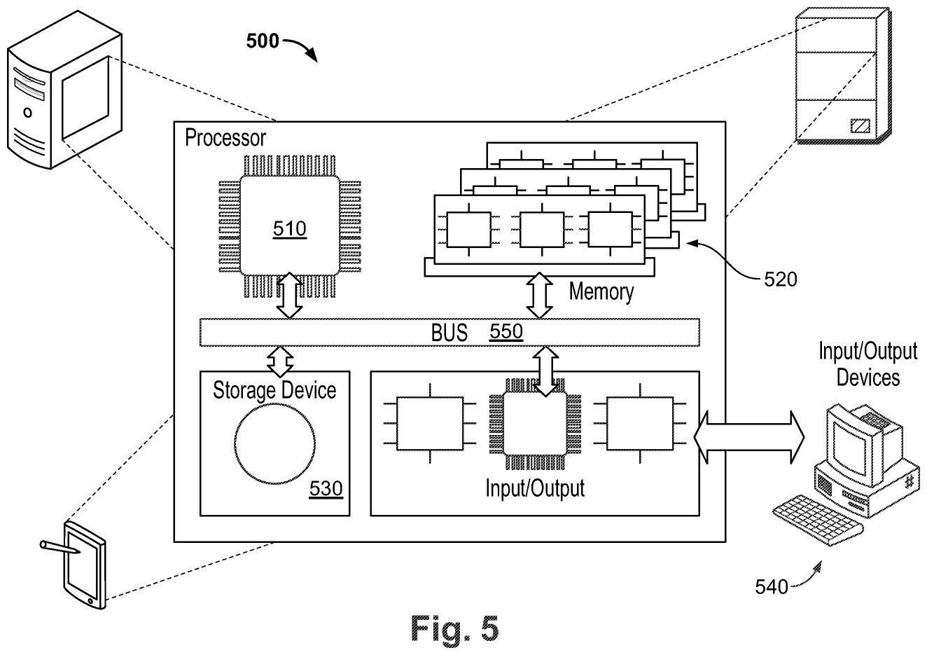

In one embodiment, if misconduct questions are to be asked of the respondent(s), the system can identify and curate a survey environment that is secure, confidential and anonymous, in which the respondent(s) will feel comfortable providing truthful answers about the misconduct without recrimination. The survey environment can include, but not limited to, an environment that the survey is conducted on a desktop computer (discussed in detail later in FIG. 5 herein) belonging to the user of the system, an environment that the survey is conducted on a tablet device belonging to the user of the system, and an environment that the survey is conducted on a mobile device belonging to the respondent of the survey.

In one embodiment, in all uses of the survey, the system can identify the respondents who will take the survey, develop and implement a mechanism for distributing the survey to the respondent(s) and for collecting the inputs, and create and disseminate a report that summarizes the results and, if the respondent(s) were asked the predictive factors questions, the system can provide potential remedial measures to be taken to mitigate risk.

In the present disclosure, the system has advantages because the questions therein can be crafted carefully, based on experience and insight, to achieve the desired user's objective(s), and because the survey has been tested, using statistical methods and analyses, and has been determined to be effective in achieving those objectives. The misconduct questions can be carefully drafted to elicit honest answers about conduct that is not in the respondent(s)' interest to disclose. By asking the misconduct questions in an environment that is secure, confidential and anonymous, the inventors of the survey have been able to elicit significant admissions of admitted misconduct from respondents in multiple countries that are reliable because the respondent(s) have no interest in overstating their admitted misconduct, and because the answers have been reviewed for evidence that the respondent(s) did not take the survey seriously.

In one embodiment, the predictive factors questions relate to multiple categories of subfactors that correlate and are predictive of the misconduct. The predictive factors questions ask about beliefs and characteristics that strongly correlate with admitted misconduct. For example, a predictive factors question can be asking a respondent if the following statement is true or not: “I feel responsible for making moral decisions at work, even if it works out negatively for me.” Each subfactor category contains questions that have been crafted carefully, based on years of experience and insight, to address the relationship between the subfactor and the misconduct, and to reflect that relationship when a regression analysis is conducted. The social desirability questions are drawn from standard statistical approaches, tweaked based on the inventors' experience and insight. For example, a social desirability question can be “Have you during the past two years made a promise that you have not kept?.”

In one embodiment, in testing the system, multiple tests in multiple countries are performed where salesperson respondents answered both the misconduct questions and the predictive factors questions, as well as the social desirability questions. The misconduct questions, because they are asked in a secure, anonymous environment, produced significant admissions of misconduct. The misconduct questions may ask the respondent whether he has committed misconduct in the past two years or is open to committing misconduct in the future. For example, the misconduct question can be “Have you during the past two years offered gifts, money or something of else of value to another person in order to sway their decision?.”Statistical analysis shows a strong relationship between many of the subfactors and the admitted misconduct, and a very strong relationship between the predictive factors overall and the admitted misconduct. Based on accepted statistical analyses and standards used in psychometric testing, the ability of the survey to predict and identify persons who are prone to corruption is quite high when compared to other tests that are commonly relied upon in making important decisions. The misconduct questions, when used in the prescribed manner, generate useful admissions of admitted misconduct, and the predictive factors questions usefully predict the likelihood that a particular respondent has engaged in misconduct. The subfactor scores yield a formula that can be used to predict the likelihood that a future respondent has engaged in misconduct, which enables a user to avoid retaining that person and/or yield insights as to specific remedial measures that can be implemented to reduce risk.

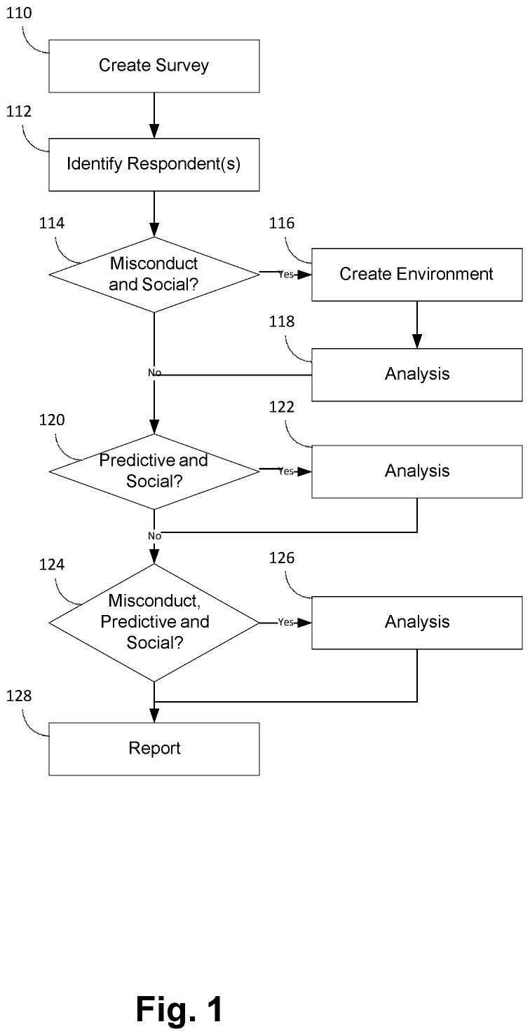

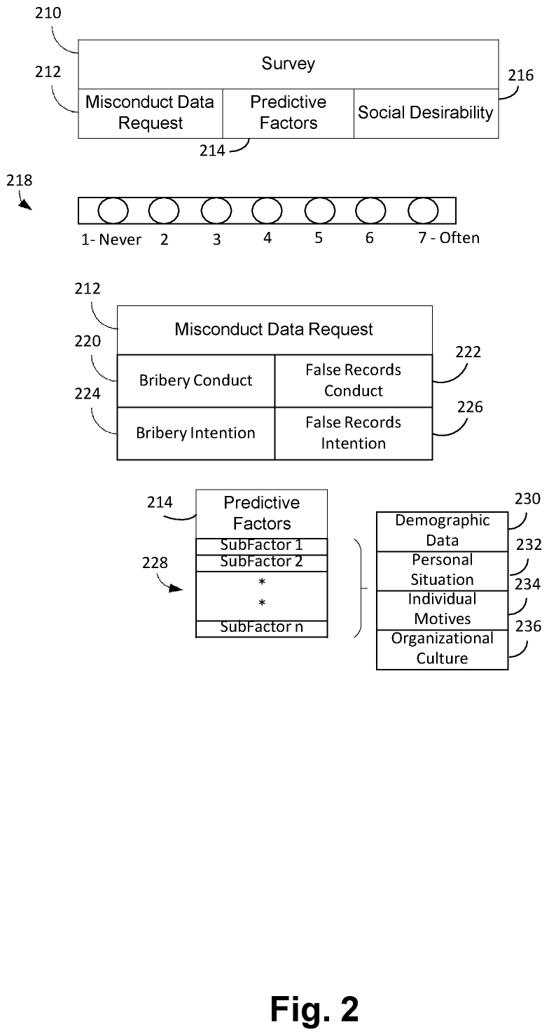

Referring to FIG. 1, this figure illustrates a flow chart of a process for a predictive corruption risk assessment, according to an embodiment of the present disclosure. At 110, a corruption risk survey 210 can be created. The corruption risk survey 210 can include several components which will be discussed in detail later in FIG. 2. At 112, the system identifies target/respondents who provide data in response to the system. At 114, the system determines whether the respondent(s) answer the misconduct questions and the social desirability questions. At 116, if the system determines that the respondent(s) are to be provided the misconduct questions, a survey environment can be created in which the respondent(s) can feel comfortable providing truthful answers about the misconduct without recrimination. The strategy that will be employed depends on the specifics or the situation and can for instance include guarantying individual anonymity, deflective priming or/and the use of comparative anchoring,

At 118, if the system determines that the respondent(s) are to be provided the misconduct questions and the social desirability questions, the estimate of the amount of misconduct can be calculated from the reported misconduct corrected for the reported social desirability. At an individual level, this can be done by utilizing the regression coefficient generated on the norm population.

At 120, the system determines whether the respondent(s) provide data in response to the predictive factors questions and the social desirability questions to assist with measuring the likelihood of misconduct as predicted by the survey. If the respondent(s) are asked only the predictive factors questions and the social desirability questions, the regression formula can be utilized at 122 to estimate the likelihood of misconduct as predicted by the survey.

The regression formula can be described as below.

Z Predicted Corruption=(β_{WBNormGroup}*((Score_{WB target}−M_{wbNormGroup})/StD_{wbNormGroup}))+(β_{STNormGroup}* ((Score_{STtarget}−M_{STNormGroup})/StD_{STNormGroup}))+(β_{FinNormGroup}* ((Score_{Fintarget}−M_{FinNormGroup})/StD_{FinNormGroup}))+(β_{ECINormGroup}* ((Score_{ECltarget}−M_{EClNormGroup})/StD_{EClNormGroup}))+(β_{BCNormGroup}* ((Score_{BCtarget}−M_{BCNormGroup})/StD_{BCNormGroup}))+(β_{MoNormGroup}* ((Score_{Motarget}−M_{MoNormGroup})/StD_{MoNormGroup}))+(β_{OVNormGroup}* ((Score_{OVtarget}−M_{OVNormGroup})/StD_{OVNormGroup}))+(β_{OCNormGroup}* ((Score_{OCtarget}−M_{OCNormGroup})/StD_{OCNormGroup}))+(β_{DSNNormGroup}* ((Score_{DSNtarget}−M_{DSNNormGroup})/StD_{DSNNormGroup}))+(β_{ISNNormGroup}* ((Score_{ISNtarget}−M_{ISNNormGroup})/StD_{ISNNormGroup}))+(β_{PNNormGroup}* ((Score_{PNtarget}−M_{PNNormGroup})/StD_{PNNormGroup}))+(β_{SDNormGroup}* ((Score_{SDtarget}−M_{SDNormGroup})/StD_{SDNormGroup}))+(interaction terms)

+Error , in which Z is a z-score representing a deviation from mean of population in standard deviations; β is a beta coefficient from regression analyses; Score is the target's score on the scale concerned; M_{norm score}=mean score on the variables concerned in the norm population; StD_{norm score} is a standard deviation on the variable concerned in the norm population; WB is weak social bonds; WT is social ties; Fin is unrelated fines; ECl is ethical climate; BC is bonus culture; Mo is mores; OV is opportunities to violate; OC is opportunities to comply; DSN is descriptive social norms; ISN is injunctive social norms; PN is personal norms; SD is social desirability. In this formula, only predictors that in the norm population significantly contribute to explaining additional variance in the analysis are entered into the equation.

At 124, the system determines if the respondent(s) are to be asked to answer the misconduct questions, the predictive factors questions, and social desirability questions to assist with measuring the extent of admitted misconduct, to measure the likelihood of misconduct as predicted by the survey, and to further study the relationship between the predictive factors and the misconduct.

If the respondent(s) are asked the misconduct questions, the predictive factors questions and the social desirability questions, at 126, a statistical analysis including the analysis in 118 and the analysis in 122 is used to measure the extent of admitted misconduct. A norm-score (e.g. t-values) is used to evaluate the reported scores on the predictive measures, and to further study the relationship between the predictive factors and the misconduct with regression techniques. See above for regression formula.

At 128, create and disseminate a report that summarizes the results and, if the respondent(s) were asked the Predictive Factors questions, provide potential remedial measures to be taken to mitigate risk.

Referring to FIG. 2, this figure illustrates a schematic diagram of a system for predictive corruption risk assessment, according to an embodiment of the present disclosure.

In one embodiment, the corruption risk survey 210 can include a first set of data requests, which can be misconduct data requests 212. The misconduct data request 212 can be carefully designed to determine the extent to which the respondent has paid a bribe in a predetermined prior of time (e.g., the past two years), is open to paying a bribe in the future, has falsified a company record in a predetermined period of time (e.g., the past two years), and is open to falsifying a company record (“the misconduct”).

In one embodiment, the corruption risk survey 210 can include a second set of data requests. The second set of data requests can be predictive factors data request 214. The predictive factor data requests 214 can include multiple potential different factors/subfactors that have been demonstrated through statistical analysis to correlate with and predict the misconduct (“the predictive factors”). The predictive factors, for instance social norms about corruption, predict the degree to which an individual is likely to commit corruption. The misconduct questions ask the respondent whether he has committed misconduct in the past two years or is open to committing misconduct in the future. The predictive factors questions ask about beliefs and characteristics that we strongly correlate with admitted misconduct as established by the misconduct questions.

In one embodiment, the corruption risk survey 210 can include a third set of data requests. The third set of data requests can be a social desirability data request 216. The social desirability data requests 216 can be designed to determine the extent to which it is likely that the respondent has provided false, socially desirable inputs, which are used to adjust the respondents' input to the misconduct data requests 212 and the predictive factor data requests 214 to make them more accurate, per established statistical techniques (“the social desirability data requests”).

In one embodiment, the responses to most of the data requests such as misconduct data request 212, predictive factor data requests 214, and social desirability data requests 216 are structured so that the respondent has multiple answer options indicating a range of potential responses. For example, for the misconduct data requests 212, input from the data requests is in the form of a 7 point Likert scale with 1=Never and 7=Often as shown by 218.

In an embodiment, the misconduct data requests 212 can be designed to determine a percentage of respondents who admit to engaging in conduct or beliefs that demonstrated corruption proneness. There can be four categories of misconduct data requests 212: bribery conduct 220; false records conduct 222; bribery intention 224; and false records Intention 226.

In one embodiment, the misconduct data requests 212 can be aimed at requesting from respondents whether the respondent has engaged in conduct or have attitudes that reflect corruption proneness in terms of potential violations of the US Foreign Corrupt Practices Act (“FCPA”) and other regulatory prohibitions and restrictions. The FCPA prohibits paying bribes non-US officials to get business and making false entries in company books. Thus, the misconduct data requests 212 can be posed in different ways, such as asking company salespeople: (1) bribery conduct—“Have you during the past two years endowed an official to get things done?”; (2) false records conduct—“Have you during the past two years reworked business records to further your goals?”; (3) bribery intention—“Can you imagine that there will be circumstances in the future under which you in your work would offer gifts, money or something of value to another person in order to sway their decision?”; (4) false records intention —“Can you imagine that there will be circumstances in the future under which you in your work would be creative with company expense accounts?”. These less overt types of data requests provide for more honest inputs.

When posing the data requests, more than one request can be presented that is directed to the misconduct subject matter. In this case, the inputs can be averages and if the average score for that subject matter is greater than a predetermined value (e.g., >2.0 on a 7-point Likert scale), it can identity targets that admit to misconduct.

In one embodiment, the predictive factors data requests 214 can include multiple subfactors such as subfactor 1 to subfactor n in 228, each of which can correlate and predict corruption proneness. The multiple subfactors can include twenty subfactors in one embodiment. Each predictive factors data request 214 can be based on a particular characteristic of the subject, or of their attitudes and beliefs. For each data request, or combination of data requests (from 212, 214 and/or 216), a hypothesis is developed and a question and answer format that best collects inputs that would test the hypothesis.

In one embodiment, the subfactors among the predictive factors 214 may be divided into multiple categories such as: demographic data 230, personal situation 232, individual motives 234, and organizational culture 236.

In one embodiment, demographic data 230 may include age, gender, living condition such as whether the respondent lives alone, family structure such as whether the respondent has children, occupation such as the respondent's job, the country in which the respondent lives, and the countries in which the respondent does business.

In one embodiment, personal situation 232 may include personal bonds (a subjective evaluation of the extent to which the respondent's personal relationships are important to her; example—“How important to you is your home?”), professional bonds (a subjective evaluation of the extent to which the respondent's professional relationships are important to her; example—“How important to you is your employer or business?”), personal ties (an objective evaluation of the number of times that the respondent's personal situation has changed; example —“During the past five years, how many times have you experienced a change of intimate relationship?”), professional ties (an objective evaluation of the number of times that the respondent's professional situation has changed; example—“During the past five years, how many times have you experienced a change of organizational function?”), and personal fines (the extent to which the respondent has incurred fines for conduct such as driving offenses and late tax filings; example—“This year, did you receive a fine relating to parking, a driving offense, late tax filing, other?”).

In one embodiment, individual motives 234 may include personal norms (what the respondent thinks about different ethical situations; example—“If no one sees or notices it, I might as well ignore a rule at work”), descriptive social norms (what the respondent's work colleagues think about different ethical situations; example—“My colleagues believe that it is always important to comply with all rules at work”), injunctive social norms (what the respondent's work colleagues do in certain situations; example—“My colleagues, if necessary, endow officials to get things done”), the respondent's opportunities to violate corruption rules (example—“In my professional situation, it is easy to grease important external decision makers into making favorable choices”), and the respondent's opportunities to fulfill her job responsibilities without violating corruption rules (example—“In my professional situation, it is easy to do my job without considering corruption”).

In one embodiment, organizational culture 236 may include ethical climate (the ethical climate of the respondent's current work environment; example—“In my team, people have a strong sense of responsibility towards society and humanity,” see Gorsira complex of ethical climate questions), bonus culture (the extent to which performance-based bonuses are important in the respondent's work environment; example—“In my team, an important part of salaries consist of performance awards (e.g. bonuses)”), and criminogenic nature (the extent to which the organization for which the respondent currently works has been sanctioned for, or a victim of, misconduct; example—“During the past five years, has your company, to your knowledge, been involved (either as a victim or a perpetrator) in corruption, forgery, tax fraud, etc.”).

In one embodiment, in analyzing the data requests (including 212 and 214) and the inputs, the social desirability data requests 216 were designed to determine whether targets were giving false, socially desirable answers. An example might be: “Have you during the past two years taken something (even a pen or a pin) that was not yours?”, or “Have you during the past two years said something unkind or insincere about somebody?”. The honest answer is yes —everyone has taken a pen home at one time or another or said something insincere. A person who answers “no” to these questions demonstrates that they are lying in order to make their answers more socially acceptable. These data requests and input can be used to adjust the target's inputs to the misconduct questions and the predictive factors questions to make the inputs more honest, per a standard statistical analysis protocol. In one embodiment, it takes a target approximately 15 minutes to provide the data requested by the entire system.

In one embodiment, the system allows an identification of which predictive factors subfactors 228 were most problematic for each target. Most of the subfactors 228 can be addressed by compliance program changes. Providing identification of these factors 214 allows for a set of remedial measures for each subfactor 228 to be developed and implemented so that preventive measures can be taken, especially with problematic targets.

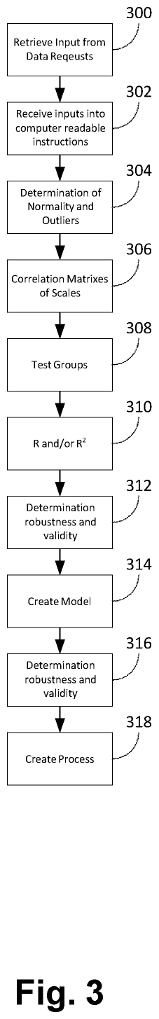

Referring to FIG. 3, this figure illustrates a flow chart of a process for a prediction of corruption, according to an embodiment of the present disclosure.

In FIG. 3, the system can receive the inputs generated according to the data requests at 300. The inputs can be in any number of formats including a statistical file format such as statistical package for the social sciences. The inputs can be imported into a set of computer readable instructions at 302. The computer readable instructions can determine the normality of distribution and outliers of the inputs at 304.

Scale analyses that include reliability, factor analyses, and structural equation models, can occur at 306. Reliability can include various analyses to determine whether the data requests and the inputs provided plausibly intended results. The factor analysis can include the determination if the social norms factors correlate and if personal and social norms correlate. The structural equation models can assist in the determination if all the data requests and inputs correlate as anticipated. At 306, correlation matrixes of scales can be constructed to determine how each data request and input correlate and how they correlate together to provide an additional verification that the data requests and inputs are producing results as anticipated.

At 308, testing can be performed between groups of targets to provide verifications that the data requests and inputs are providing anticipated responses.

At 310, models can be created configured to predict corruption that can be for the set, group, or subgroup of scales. The groups can include background variables, organizational culture, personal situation, personal motives and can use regression techniques to arrive as a result. The results can be measured by the R number or R² number. At 312, a determination for robustness and validity of models can be made that can use boot strap techniques and controlling for social desirability bias. At 314, a model can be created for predicting corruption that can be for all relevant scales and can be based on regression techniques. This can be the final regression analysis that analyzes R and R² for the set of predictive factors in one embodiment.

At 316, a second determination for robustness and validity of the model can be made that can use boot strap techniques and controlling for social desirability bias in one embodiment. At 318, the creation of a stable process for the prediction of corruption can be made where regression analysis can be built into the process.

### A Sample Test of the System.

In one embodiment, the data results and inputs can be posed and received by a third party. In one test of the system and the method in the present disclosure, a third party paid targets to provide input to various data requests. One test includes four hundred targets in the United Kingdom and one hundred targets each in the United States, the Philippines, India and Nigeria. The five countries represented a wide variety of levels of perceived corruption, according to Transparency International's Corruption Perceptions Index, a respected global corruption index.

The Demographic Data subfactors may be used to identify specific groups from whom to collect data. It is accepted, for example, that salespeople present relatively greater FCPA risk because they are in a position to pay bribes to get business, and that FCPA risk varies by country, as different countries have different levels of acceptance of bribery and different levels of enforcement activity. In the test, respondents are limited to business-to-business salespeople who work for companies which have at least ten employees and at least two people working in sales.

The salespeople targets in the five countries are requested to provide data in response to the four sets of misconduct data requests, the seventeen sets of predictive factor data requests other than job and country of residence/business, and the social desirability data requests. In analyzing the inputs, a set of targets that admitted wrongdoing were identified, and a set of targets who do not admit wrongdoing were identified. Their data provides in response to the seventeen subfactor data requests were analyzed to determine if the seventeen subfactors, and the system overall, correlated with and predicted corrupt misconduct. A multiple factor regression analysis is performed, which measures the correlation and predictive value of each of the seventeen subfactors, as well as the predictive factors overall, for each category of misconduct questions.

The four sets of misconduct data requests results in responses indicating a significant percentage of admitted misconduct, in all four categories and in all five countries. The regression analysis shows that the predictive factors were remarkably strong in predicting which respondents admitted to the Misconduct. After the set of relevant subfactors for each type of misconduct in each country was developed, statistical techniques are used to create formulas that, when applied to a target's input to the predictive factor questions, predicts whether a particular target had admitted to engaging in a particular type of Misconduct. The formula, which depends on the country and the type of misconduct, is used for one category of misconduct in one country (e.g., bribery misconduct in the UK) to determine how effective the system is in identifying targets who had admitted to the misconduct. Prior to application of the formula, 35.5% of the targets have admitted to engaging in bribery conduct, so an employer hiring from that pool had a 35.5% chance of hiring a person who has admitted to engaging in bribery conduct. Applying the formula and considering only those targets who the formula predicts do not admit to engaging in bribery conduct, the percentage of targets who have actually admitted to engaging in bribery conduct was reduced from 35.5% to 7%.

Additional details regarding the results of this test are as follows. Results for bribery conduct and false records conduct refer to data requests that request input from targets if the target had engaged in the specified misconduct in the past two years. Bribery intention and false records intention refer to data requests that asked the target for input concerning if the target could imagine themselves engaging in bribery or false record misconduct in the future. For each of the four categories of misconduct, the targets in the five countries were asked to respond to a 7-item Likert scale with 1 equal to Never, and 7 equals to Often. Targets whose average response was greater than 2 were deemed to have admitted having engaged in the misconduct. The numbers for admitted misconduct in the twenty responses (four categories of misconduct in five countries) ranged from 23% for US bribery conduct, to 86% for India false records intention. Twelve of the twenty responses were over 50% in admitted misconduct, with the other eight responses under 50%.

R and R² are statistical measures used to measure the predictive value of the present system and method. R measures correlation between the system and the identified type of misconduct; R² measures the percentage of the variability in the identified type of misconduct predicted by the system. R=\sqrt{R}². According to the US Office of Personnel Management, in the employment testing context, R values “for a single assessment rarely exceed 0.50.” An R value “of 0.30 or higher is generally considered useful for most circumstances.” The ACT test has an R value of 0.45 in terms of its ability to predict first year college performance.

In connection with the test described above, the R values and the R² values for the overall system are calculated as to each category of misconduct, in each of the five countries. In testing and implementation of the present system, the lowest R value is 0.45 for false records conduct in Nigeria (the same as the ACT test). A substantial majority of the R values (seventeen out of twenty) are greater than 0.50, which is “rarely” achieved by any single assessment. Fifteen of the twenty R values exceed 0.60, and eleven of the twenty R values exceed 0.70. The average R value is 0.67. These results show that the present system provides unexpected and remarkably strong results as to predictive value.

In this test, the most predictive subfactor overall is opportunities to violate, which constitutes 37% of the overall predictive value of the system. The other 63% is explained by other factors, including social norms, personal norms, social ties, social bonds and organizational ethical climate, most of which can be affected by changes in the compliance culture.

This test of the system also demonstrated its ability to identify corruption prone persons and potentially eliminate them from consideration in personnel decisions. The focus is on UK targets who admitted to having engaged in bribery conduct, as defined above. For ease of explication, targets who admit to bribery conduct are referred to herein as red, while those who claim that they have not engaged in bribery conduct are referred to as green. Of the 403 UK targets, 35.5% admitted bribery conduct (i.e., 143 participants were red). 64.5% claimed that they have not committed bribery misconduct (i.e., 260 participants were green). Thus, if an employer were to hire from this pool, the employer may have a 35.5% chance of hiring a red target.

Using statistical regression techniques derived from the results of the test, a regression formula is created that predicts whether a participant is red or green. The regression formula starts with:

Compute Predicted Corruption=3.359+(WB*0.084)+(ECl*0.202)+(OV *0.349)+(OC*−0.016) +(DSN*−0.155)+(ISN*−0.234)+(PN*−0.014)+(SD*−0.170).

### Followed by:

if (corruption_index_score le 2) cat_PredictedCorruption=0.
if (corruption_index_score gt 2) cat_PredictedCorruption=1.
value labels cat_cat_PredictedCorruption 0 ‘Green’ 1 ‘Orange or Red’.

This formula is applied to the 403 participants via the bootstrapping approach. 189 of the 403 participants tested as green, which is 47%. Of those 189, 93% actually were green, which is 176 participants (survey formula was correct as to these participants), and of those 189, 7% actually were red, which is 13 participants (survey formula was incorrect as to these participants). Therefore, if an employer applied the system to the pool and only considered hiring those who tested as green, the employer would reduce its likelihood of retaining an actual red from 35.5% to 7%.

Concerning targets who test red, 214 of the 403 participants tested as red, which is 53%. Of those 214, 39% actually were green, which is 84 participants (survey formula was wrong as to these participants). Of those 214, 61% actually were red, which is 130 participants (survey formula was correct as to these participants). Therefore, the survey system eliminated 84 of the 260 people (32%) who actually were green.

Overall, the system is correct in predicting a participant's color (red or green) as to 306 of the 403 participants, which is 76%, while the system was wrong as to 97 of the 403 participants, which is 24%.

FIG. 4 is a schematic of a user device for performing a method for predictive corruption risk assessment, according to an embodiment of the present disclosure.

An example of the user device 400 for the respondent of a questionnaire is shown in FIG. 4. For example, the respondent may use the user device 400 to answer the questionnaire discussed earlier. In some examples, the user device 400 may also be also used by a survey administrator to choose types of survey for the respondent before the user device 400 is given to the respondent. FIG. 4 is also a detailed block diagram illustrating an exemplary electronic user device 400. In certain embodiments, the user device 400 may be a smartphone, a desktop computer, or a tablet. However, the skilled artisan will appreciate that the features described herein may be adapted to be implemented on other devices (e.g., a laptop, a tablet, a server, an e-reader, a camera, a navigation device, etc.). The exemplary user device 400 of FIG. 4 includes a controller 410 and a wireless communication processor 402 connected to an antenna 401. A speaker 404 and a microphone 405 are connected to a voice processor 403.

The controller 410 may include one or more Central Processing Units (CPUs) and one or more Graphics Processing Units (GPUs), and may control each element in the user device 400 to perform functions related to communication control, audio signal processing, graphics processing, control for the audio signal processing, still and moving image processing and control, and other kinds of signal processing. The controller 410 may perform these functions by executing instructions stored in a memory 450. Alternatively or in addition to the local storage of the memory 450, the functions may be executed using instructions stored on an external device accessed on a network or on a non-transitory computer readable medium. In the present disclosure, the controller 410 may control which types of data requests display on the screen of the user device 400. The controller 410 may determine a specific misconduct data request and/or a specific predictive factor data request based on an identified target for the corruption risk assessment. For example, as discussed above, the controller 410 may determine a specific misconduct data request to ascertain whether the respondent has engaged in bribery conduct and/or a specific predictive factor data request for social norms, personal norms, social bonds, personal bonds and ethical climate.

The memory 450 includes but is not limited to Read Only Memory (ROM), Random Access Memory (RAM), or a memory array including a combination of volatile and non-volatile memory units. The memory 450 may be utilized as working memory by the controller 410 while executing the processes, formula, and algorithms of the present disclosure. The memory 450 may store inputs such as predictive factors input and misconduct input. Additionally, the memory 450 may be used for short-term or long-term storage, e.g., of image data and information related thereto. The memory 450 may store inputs from the respondent of the questionnaire. The memory 450 may also store data requests including the misconduct data request, predictive factor data request, and social desirability data request as discussed earlier.

The user device 400 includes a control line CL and data line DL as internal communication bus lines. Control data to/from the controller 410 may be transmitted through the control line CL. The data line DL may be used for transmission of voice data, display data, etc.

The antenna 401 transmits/receives electromagnetic wave signals between base stations for performing radio-based communication, such as the various forms of cellular telephone communication. The wireless communication processor 402 controls the communication performed between the user device 400 and other external devices via the antenna 401. For example, the wireless communication processor 402 may control communication between base stations for cellular phone communication.

The speaker 404 emits an audio signal corresponding to audio data supplied from the voice processor 403. The microphone 405 detects surrounding audio and converts the detected audio into an audio signal. The audio signal may then be output to the voice processor 403 for further processing. The voice processor 403 demodulates and/or decodes the audio data read from the memory 450 or audio data received by the wireless communication processor 402 and/or a short-distance wireless communication processor 407. Additionally, the voice processor 403 may decode audio signals obtained by the microphone 405.

The exemplary user device 400 may also include a display 420, a touch panel 430, an operation key 440, and a short-distance communication processor 407 connected to an antenna 406. The display 420 may display the contents such as a corruption risk survey or questionnaires discussed earlier. The display 420 may be a Liquid Crystal Display (LCD), an organic electroluminescence display panel, or another display screen technology. In addition to displaying still and moving image data, the display 420 may display operational inputs, such as numbers or icons which may be used for control of the user device 400. The numbers or icons may be used for the respondent to answer the questionnaire. The display 420 may additionally display a GUI for a user to control aspects of the user device 400 and/or other devices. Further, the display 420 may display characters and images received by the user device 400 and/or stored in the memory 450 or accessed from an external device on a network. For example, the user device 400 may access a network such as the Internet and display text and/or images transmitted from a Web server.

The touch panel 430 may include a physical touch panel display screen and a touch panel driver. The touch panel 430 may include one or more touch sensors for detecting an input operation on an operation surface of the touch panel display screen. The touch panel 430 also detects a touch shape and a touch area. Used herein, the phrase “touch operation” refers to an input operation performed by touching an operation surface of the touch panel display with an instruction object, such as a finger, thumb, or stylus-type instrument. In the case where a stylus or the like is used in a touch operation, the stylus may include a conductive material at least at the tip of the stylus such that the sensors included in the touch panel 430 may detect when the stylus approaches/contacts the operation surface of the touch panel display (similar to the case in which a finger is used for the touch operation). The respondent of the survey or the questionnaire may use the touch panel 430 to answer the questions provided by the user device 400. In some examples, a survey administrator may also use the touch panel 430 to choose types of the surveys for the respondent of the survey.

In certain aspects of the present disclosure, the touch panel 430 may be disposed adjacent to the display 420 (e.g., laminated) or may be formed integrally with the display 420. For simplicity, the present disclosure assumes the touch panel 430 is formed integrally with the display 420 and therefore, examples discussed herein may describe touch operations being performed on the surface of the display 420 rather than the touch panel 430. However, the skilled artisan will appreciate that this is not limiting.

For simplicity, the present disclosure assumes the touch panel 430 is a capacitance-type touch panel technology. However, it should be appreciated that aspects of the present disclosure may easily be applied to other touch panel types (e.g., resistance-type touch panels) with alternate structures. In certain aspects of the present disclosure, the touch panel 430 may include transparent electrode touch sensors arranged in the X-Y direction on the surface of transparent sensor glass.

The touch panel driver may be included in the touch panel 430 for control processing related to the touch panel 430, such as scanning control. For example, the touch panel driver may scan each sensor in an electrostatic capacitance transparent electrode pattern in the X-direction and Y-direction and detect the electrostatic capacitance value of each sensor to determine when a touch operation is performed. The touch panel driver may output a coordinate and corresponding electrostatic capacitance value for each sensor. The touch panel driver may also output a sensor identifier that may be mapped to a coordinate on the touch panel display screen. Additionally, the touch panel driver and touch panel sensors may detect when an instruction object, such as a finger is within a predetermined distance from an operation surface of the touch panel display screen. That is, the instruction object does not necessarily need to directly contact the operation surface of the touch panel display screen for touch sensors to detect the instruction object and perform processing described herein. For example, in certain embodiments, the touch panel 430 may detect a position of a user's finger around an edge of the display panel 420 (e.g., gripping a protective case that surrounds the display/touch panel). Signals may be transmitted by the touch panel driver, e.g. in response to a detection of a touch operation, in response to a query from another element based on timed data exchange, etc.

The touch panel 430 and the display 420 may be surrounded by a protective casing, which may also enclose the other elements included in the user device 400. In certain embodiments, a position of the user's fingers on the protective casing (but not directly on the surface of the display 420) may be detected by the touch panel 430 sensors. Accordingly, the controller 410 may perform display control processing described herein based on the detected position of the user's fingers gripping the casing. For example, an element in an interface may be moved to a new location within the interface (e.g., closer to one or more of the fingers) based on the detected finger position.

The operation key 440 may include one or more buttons or similar external control elements, which may generate an operation signal based on a detected input by the user. In addition to outputs from the touch panel 430, these operation signals may be supplied to the controller 410 for performing related processing and control.

The antenna 406 may transmit/receive electromagnetic wave signals to/from other external apparatuses, and the short-distance wireless communication processor 407 may control the wireless communication performed between the other external apparatuses. Bluetooth, IEEE 802.11, and near-field communication (NFC) are non-limiting examples of wireless communication protocols that may be used for inter-device communication via the short-distance wireless communication processor 407.

The user device 400 may include a motion sensor 408. The motion sensor 408 may detect features of motion (i.e., one or more movements) of the user device 400. For example, the motion sensor 408 may include an accelerometer to detect acceleration, a gyroscope to detect angular velocity, a geomagnetic sensor to detect direction, a geo-location sensor to detect location, etc., or a combination thereof to detect motion of the user device 20. In certain embodiments, the motion sensor 408 may generate a detection signal that includes data representing the detected motion. For example, the motion sensor 408 may determine a number of distinct movements in a motion (e.g., from start of the series of movements to the stop, within a predetermined time interval, etc.), a number of physical shocks on the user device 400 (e.g., a jarring, hitting, etc., of the electronic device), a speed and/or acceleration of the motion (instantaneous and/or temporal), or other motion features. The detected motion features may be included in the generated detection signal. The detection signal may be transmitted, e.g., to the controller 410, whereby further processing may be performed based on data included in the detection signal. The motion sensor 408 can work in conjunction with a Global Positioning System (GPS) section 460. The information of the present position detected by the GPS section 460 is transmitted to the controller 410. An antenna 461 is connected to the GPS section 460 for receiving and transmitting signals to and from a GPS satellite.

The user device 400 may include a camera section 409, which includes a lens and shutter for capturing photographs of the surroundings around the user device 400. In an embodiment, the camera section 409 captures surroundings of an opposite side of the user device 400 from the user. The images of the captured photographs can be displayed on the display panel 420. A memory section saves the captured photographs. The memory section may reside within the camera section 109 or it may be part of the memory 450. The contents of the layers 102 and 104 discussed earlier may be retrieved from the memory section 409 or the memory 450. The camera section 409 can be a separate feature attached to the user device 400 or it can be a built-in camera feature.

An example of a type of user's computer is shown in FIG. 5, which shows a schematic diagram of a generic computer system 500. The user's computer may be the desktop computer for the respondent of the survey or the questionnaire described earlier.

The system 500 can be used for the operations described in association with any of the method described previously such as the method 200, according to one implementation. The system 500 includes a processor 510, a memory 520, a storage device 530, and an input/output device 540. Each of the components 510, 520, 530, and 540 is interconnected using a system bus 550. The processor 510 is capable of processing instructions for execution within the system 500. In one implementation, the processor 510 is a single-threaded processor. In another implementation, the processor 510 is a multi-threaded processor. The processor 510 is capable of processing instructions stored in the memory 520 or on the storage device 530 to display graphical information for a user interface on the input/output device 540.

As discussed earlier, the processor 510 may be used to identify the target. The processor 510 may be used to analyze the aggregated misconduct inputs and predictive factors inputs. The processor 510 may be used to generate a report after analyzing the aggregated misconduct and predictive factors inputs. The processor 510 may use the regression formula discussed earlier to correlate the predictive factors with admitted misconduct of the respondent of the survey.

The memory 520 stores information within the system 500. In one implementation, the memory 520 is a computer-readable medium. In one implementation, the memory 520 is a volatile memory unit. In another implementation, the memory 520 is a non-volatile memory unit.

The storage device 530 is capable of providing mass storage for the system 500. In one implementation, the storage device 530 is a computer-readable medium. In various different implementations, the storage device 530 may be a floppy disk device, a hard disk device, an optical disk device, or a tape device. The storage device 530 may store data requests including the misconduct data request, predictive factor data request, and social desirability data request as discussed earlier. The storage device 530 may store surveys such as corruption risk survey discussed earlier. The storage device 530 may store the response inputs from the respondents. The storage device 530 may store the results of the questionnaire that the respondent answers.

The input/output device 540 provides input/output operations for the system 500. In one implementation, the input/output device 540 includes a keyboard and/or pointing device. In another implementation, the input/output device 540 includes a display unit for displaying graphical user interfaces.

While this specification contains many specific implementation details, these should not be construed as limitations on the scope of what may be claimed, but rather as descriptions of features that may be specific to particular embodiments.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

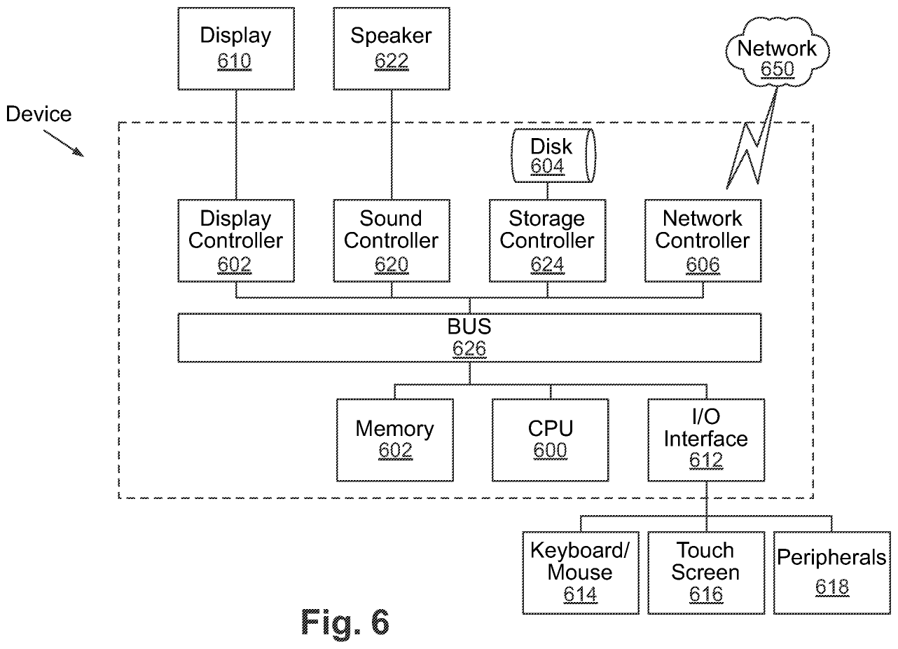

FIG. 6 is a schematic of a hardware configuration of a device for performing a method, according to an embodiment of the present disclosure.

Next, a hardware description of a device according to exemplary embodiments is described with reference to FIG. 6. In FIG. 6, the device includes processing circuitry which may in turn include a CPU 600 which performs the processes described above/below. As noted above, the processing circuitry performs the functionalities of the process in the present disclosure. The processing circuitry may determine a score for the Likert scale of the misconduct input. For example, the processing circuitry may determine that the respondent has a score of 1, which means that the respondent has never had misconduct.

The process data and instructions may be stored in memory 602. These processes and instructions may also be stored on a storage medium disk 604 such as a hard drive (HDD) or portable storage medium or may be stored remotely. Further, the claimed advancements are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the device communicates, such as a server or computer.

Further, the claimed advancements may be provided as a utility application, background daemon, or component of an operating system, or combination thereof, executing in conjunction with CPU 600 and an operating system such as Microsoft Windows, UNIX, Solaris, LINUX, Apple MAC-OS and other systems known to those skilled in the art.

The hardware elements in order to achieve the device may be realized by various circuitry elements, known to those skilled in the art. For example, CPU 600 may be a Xenon or Core processor from Intel of America or an Opteron processor from AMD of America, or may be other processor types that would be recognized by one of ordinary skill in the art. Alternatively, the CPU 600 may be implemented on an FPGA, ASIC, PLD or using discrete logic circuits, as one of ordinary skill in the art would recognize. Further, CPU 600 may be implemented as multiple processors cooperatively working in parallel to perform the instructions of the processes described above.

The device in FIG. 6 also includes a network controller 606, such as an Intel Ethernet PRO network interface card from Intel Corporation of America, for interfacing with network 650. As can be appreciated, the network 650 can be a public network, such as the Internet, or a private network such as an LAN or WAN network, or any combination thereof and can also include PSTN or ISDN sub-networks. The network 650 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The device further includes a display controller 608, such as a NVIDIA GeForce GTX or Quadro graphics adaptor from NVIDIA Corporation of America for interfacing with display 610, such as an LCD monitor. A general purpose I/O interface 612 interfaces with a keyboard and/or mouse 614 as well as a touch screen panel 616 on or separate from display 610. General purpose I/O interface also connects to a variety of peripherals 618 including printers and scanners.

A sound controller 620 is also provided in the device to interface with speakers/microphone 622 thereby providing sounds and/or music.

The general purpose storage controller 624 connects the storage medium disk 604 with communication bus 626, which may be an ISA, EISA, VESA, PCI, or similar, for interconnecting all of the components of the device. A description of the general features and functionality of the display 610, keyboard and/or mouse 614, as well as the display controller 608, storage controller 624, network controller 606, sound controller 620, and general purpose I/O interface 612 is omitted herein for brevity as these features are known.

It is to be understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

Obviously, numerous modifications and variations are possible in light of the above teachings. It is therefore to be understood that within the scope of the appended claims, embodiments of the present disclosure may be practiced otherwise than as specifically described herein.

What is claimed is:

1. A method for predictive corruption risk assessment, comprising:
identifying a target for assessing corruption risk;
providing a set of misconduct data requests;
receiving misconduct input associated with each misconduct data request in the set of misconduct data requests;
providing a set of predictive factors data requests;
receiving predictive factors input associated with each predictive factors data request in the set of predictive factors data requests, the set of predictive factors data requests statistically correlating with the set of misconduct data requests, each predictive factors data request of the set of predictive factors data requests being from at least one or more categories;
aggregating the misconduct input and the predictive factors input;
analyzing the aggregated misconduct and predictive factors inputs; and
generating a report based on the analysis, the report reflecting the aggregated misconduct and predictive factors inputs.

2. The method of claim 1, wherein the misconduct input is in a form of a seven-point Likert scale with one being “never” and seven being “often”.

3. The method of claim 1, wherein each misconduct data request of the set of misconduct data requests is from at least one of categories: bribery conduct, false records conduct, bribery intention, and false records intention.

4. The method of claim 1, wherein the one or more categories include demographic data, personal situation, individual motives, and organizational culture.

5. The method of claim 4, wherein the demographic data includes at least one of age, gender, living condition, family structure, occupation, and country.

6. The method of claim 4, wherein the personal situation includes at least one of personal bonds, professional bonds, personal ties, professional ties, and personal fines.

7. The method of claim 4, wherein the individual motives include at least one of personal norms, descriptive social norms, injunctive social norms, opportunities to violate corruption rules, and opportunities to fulfill job responsibilities without violating corruption rules.

8. The method of claim 4, wherein the organizational culture includes at least one of ethical climate, bonus culture, and criminogenic nature.

9. The method of claim 1, further comprising analyzing the misconduct input based on social desirability data requests and social desirability inputs to determine whether the misconduct input is false and/or socially desirable.

10. The method of claim 1, further comprising analyzing the predictive factors input based on social desirability data requests and social desirability inputs to determine whether the predictive factors input is false and/or socially desirable.

11. The method of claim 1, further comprising determining whether the target is presented with at least one of data requests, social desirability data requests, and factors.

12. The method of claim 1, further comprising identifying and providing an input collection environment that is secure, confidential and anonymous.

13. The method of claim 1, wherein the analysis is performed by a regression formula, the regression formula correlating predictive factors with admitted misconduct.

14. The method of claim 1, further comprising predicting, by a regression formula, is created that predicts whether a respondent has engaged in admitted misconduct.

15. A system for predictive corruption risk assessment, comprising:
processing circuitry configured to
identify a target for assessing corruption risk;
provide a set of misconduct data requests;
receive misconduct input associated with each misconduct data request in the set of misconduct data requests;
provide a set of predictive factors data requests;
receive predictive factors input associated with each predictive factors data request in the set of predictive factors data requests, the set of predictive factors data requests statistically correlating with the set of misconduct data requests, each predictive factors data request of the set of predictive factors data requests being from at least one or more categories;
aggregate the misconduct input and the predictive factors input;
analyze the aggregated misconduct and predictive factors inputs; and
generate a report based on the analysis, the report reflecting the aggregated misconduct and predictive factors inputs.

16. The system of claim 15, wherein each misconduct data request of the set of misconduct data requests is from at least one of categories: bribery conduct, false records conduct, bribery intention, and false records intention.

17. The system of claim 15, wherein the one or more categories include demographic data, personal situation, individual motives, and organizational culture.

18. The system of claim 17, wherein the demographic data includes at least one of age, gender, living condition, family structure, occupation, and country.

19. The system of claim 17, wherein the personal situation includes at least one of personal bonds, professional bonds, personal ties, professional ties, and personal fines.

20. The system of claim 17, wherein the individual motives include at least one of personal norms, descriptive social norms, injunctive social norms, opportunities to violate corruption rules, and opportunities to fulfill job responsibilities without violating corruption rules.

21. The system of claim 17, wherein the organizational culture includes at least one of ethical climate, bonus culture, and criminogenic nature.

22. The system of claim 15, wherein the analysis is performed by a regression formula, the regression formula correlating predictive factors with admitted misconduct.

23. A non-transitory computer-readable storage medium storing computer-readable instructions that, when executed by a computer, cause the computer to perform a method, the method comprising:
identifying a target for assessing corruption risk;
providing a set of misconduct data requests;
receiving misconduct input associated with each misconduct data request in the set of misconduct data requests;
providing a set of predictive factors data requests;
receiving predictive factors input associated with each predictive factors data request in the set of predictive factors data requests;
aggregating the misconduct input and the predictive factors input;
analyzing the aggregated misconduct and predictive factors inputs; and
generating a report based on the analysis.
